(19) United States
(12) Patent Application Publication
(10) Pub. No.: US 2005/0017501 A1
(43) Pub. Date: Jan. 27, 2005

(54) Sports items with hidden memorabilia

(76) Inventor: Adrian Gluck, Beverly Hills, CA (US)

Correspondence Address: BARLOW, JOSEPHS & HOLMES, LTD., 101 DYER STREET, 5TH FLOOR, PROVIDENCE, RI, 02903, US

(21) Appl. No.: 10/892,865

(22) Filed: Jul. 16, 2004

Related U.S. Application Data
(60) Provisional application No. 60/488,977, filed on Jul. 22, 2003.

(51) Int. Cl. B42D 15/00

(52) U.S. Cl. 283/72

(57) ABSTRACT

A means and method of providing a novel collectible memorabilia item is disclosed. The present invention involves concealing a memorabilia item that is affixed to a carrier item by the manufacturer thereof. To ensure that the memorabilia item remains hidden, so that they can only be seen by buyers after they have paid for their purchase, the protective devices could optionally be tamper-proofed. Additionally, the means for concealment includes protective devices and/or the optional tamper-proofing devices in addition to components similar to those currently utilized in anti-theft systems. In addition to protecting the memorabilia item and ensuring that it remains with the carrier item, by concealing the memorabilia an element of chance is introduced to the purchasing process. Accordingly, the true value of the carrier item and the memorabilia item attached there to is not revealed until the carrier item is purchased and the protective device is then removed.

### CROSS-REFERENCE TO RELATED APPLICATIONS

This application is related to and claims priority from earlier filed US Provisional patent application Ser. No. ______, filed Jul. 18, 2003, entitled Product and Method of Manufacturing Items with Hidden Memorabilia, and earlier filed U.S. Provisional Application No. 60/488,977, filed Jul. 22, 2003, the entire contents of which are incorporated herein by reference.

### BACKGROUND OF THE INVENTION

The present invention relates generally to collectible memorabilia items. More specifically, the present invention relates to providing an item of historic or celebrity memorabilia that is concealed within specially designed areas of consumer products, such as wearing apparel, to provide an element of chance and surprise for the purchaser of the product as well as protecting the memorabilia item until the consumer product is purchased.

It is well-known today that individual professional athletes in various sports such as basketball, baseball, football, tennis, hockey, etc. have attracted great followings in the public. Similarly, celebrities within the entertainment industry also attract a great deal of attention from the public at large. Further, the public regards these athletes and celebrities with a great deal of honor and esteem. Buyers of consumer products, especially sport-related apparel and equipment, place a higher degree of trust on their quality and performance if such items are endorsed by famous personalities and organizations. Consequently, there have been a number of products on the market relating celebrities and particularly to athletes. One example of such products relating to athletes are trading cards, wherein the picture of the individual athlete is printed on a card with statistics or other information relating to the player also printed on the card. Cards usually include the player's team, his position, uniform number, and other information.

In addition to trading cards, various devices or implements and pieces of clothing, such as baseballs, baseball bats, footballs, basketballs, jerseys, shoes, musical instruments, etc., are marketed in conjunction with photographs, plaques, and the like, as memorabilia. Just a few examples include autographed baseballs, footballs, and the like, as well as photographs or trading cards with an actual autograph. Additionally, these items include some form of authentication in the form of a serial number, hologram, or the like. In some cases the memorabilia item (e.g., baseball, bat, football, etc.) is the one used for some particular memorable event (e.g., 40th home run, 100th touchdown pass, 1000th concert, etc.), and is retained by the famous figure involved. Alternatively, the memorabilia item may be sold at a relatively high price by that person or someone else. Unfortunately, the high price of such items generally places them outside of the ability of youngsters and average income families to purchase or otherwise obtain them.

Accordingly, there is a well established market for “signature” products that bear an imprint of famous athlete's names, logo insignias, and/or replicas of their autographs. Similarly, as discussed above, another market exists for memorabilia such as sports jerseys, footwear, balls, caps, and costumes and props that have been either used and/or autographed by famous sports and entertainment personalities. Finally, it has also been established that yet another established market exists for collectible and/or souvenir items that display logos and names of sports teams, TV shows, or movies; pictures of famous athletes, TV actors and movie actors; and commemorate places and events. Examples of prior art memorabilia items that are particularly illustrative of the type referred to are disclosed in U.S. Pat. Nos. 5,803,501 and 6,142,532, both issued to Gluck, the contents of which are fully incorporated herein by reference.

There is therefore a perceived need for a unique product that includes elements that satisfy the consumer's desires to possess such memorabilia at an affordable price that also allows cross-marketing within the above identified markets. Further, there is a perceived need for a means and method of providing discrete elements of memorabilia in connection with consumer marketed items, such as items of wearing apparel, while ensuring that the memorabilia remains intact on the items during shipping, storage, handling and retail sales so that it ultimately winds up in the end consumer's possession.

### BRIEF SUMMARY OF THE INVENTION

In this regard, the present invention provides for a consumer item bearing an item of memorabilia. The memorabilia item may or may not be affixed to the consumer item in a concealed manner. As such, the general purpose of the present invention, which will be described subsequently in greater detail, is to provide a series of consume items containing a memorabilia item. Further, an additional purpose of the present invention is to provide a means and method of providing a “signature” series of consumer items wherein the majority of the items include a generic machine imprinted memorabilia item but also wherein a selected number of the series actually contain a real memorabilia item.

The present invention involves providing a line of consumer items that includes a memorabilia item and/or a means of authentication and/or a means for concealing the memorabilia item affixed thereto. Additionally, the present invention provides for hiding one or a combination of the following: machine-imprinted signatures or authentic handwritten signatures of famous sports, historic or entertainment personalities such as athletes, actors, politicians, animated characters, persons who have accomplished particular achievements; imprinted logo insignia; and/or memorabilia such as pieces of event-used jerseys, costumes and sports equipment; (together referred to as “memorabilia”) on or within consumer products such as apparel, accessories, footwear, souvenirs, collectibles, and sports equipment (together referred to as “carrier items”). In accordance with the present invention, the “memorabilia” are hidden from view using labels, tags, stickers, sleeves, invisible and/or dissolvable inks or dyes, wrappers, cards, security devices or other such protective devices. To ensure that the “memorabilia” remain hidden, so that they can only be seen by buyers after they have paid for their purchase, the protective devices could optionally be tamper-proofed. Additionally, the protective devices and/or the optional tamper-proofing devices could be used as components in anti-theft systems similar to those currently available from Checkpoint Systems, Inc., Sensormatic Electronics Corporation and others. In addition, the memorabilia may directly relate to the carrier item (e.g., a shoe might incorporate a piece of a shoe from an athlete, a jersey may include material from an athlete's uniform, a baseball bat could incorporate a piece of a bat from a baseball player and item of clothing might incorporate a piece of clothing worn by an actor wearing the same or similar clothing.)

In addition to protecting the memorabilia item and ensuring that it remains with the carrier item, by concealing the memorabilia an element of chance is introduced to the purchasing process. Specifically, only some of the carrier items bear an authentic original memorabilia item while the remaining carrier items bear a reproduction memorabilia item. The true value of the carrier item and the memorabilia item attached there to is not revealed until the carrier item is purchased and the protective device is then removed.

Accordingly, it is an object of the present invention to provide a “signature” series of carrier items such as wearing apparel, sneakers, etc. having a memorabilia item affixed thereto. It is another object of the present invention to provide a “signature” series of carrier items such as wearing apparel, sneakers, etc. having a memorabilia item affixed thereto wherein the memorabilia item concealed from view until after the carrier item is purchased. It is a further object of the present invention to provide a “signature” series of carrier items wherein a majority portion of the carrier items have a reproduction memorabilia item affixed thereto and a remaining portion of the carrier items have an authentic memorabilia item affixed thereto, the identity of the nature of the memorabilia item being concealed until the carrier item is purchased. It is yet a further object of the present invention to provide a carrier item having a memorabilia item affixed thereto wherein the memorabilia item is concealed from view by means that includes anti-tamper features.

These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated several illustrative embodiments of the invention.

### BRIEF DESCRIPTION OF THE DRAWINGS

In the drawings which illustrate the best mode presently contemplated for carrying out the present invention:

FIG. 1 is a front perspective view of a first preferred embodiment of the present invention showing a pair of athletic shoes having a memorabilia signature affixed thereto;

FIG. 2 is a front perspective view of the athletic shoes in FIG. 1 with a memorabilia seal applied over the memorabilia item;

FIG. 3 is a front perspective view of the athletic shoes in FIG. 1 with a memorabilia shield applied over the memorabilia seal;

FIG. 4 is a front perspective view of a second embodiment of the present invention showing a pair of athletic shoes having a memorabilia object affixed onto a secondary carrier;

FIG. 5 is a front perspective view of a third embodiment of the present invention showing a jersey having a memorabilia signature affixed thereto;

FIG. 6 is a front perspective view of a fourth embodiment of the present invention showing a jersey having a memorabilia object affixed onto a secondary carrier;

FIG. 7 is a front perspective view of a fifth embodiment of the present invention showing a baseball bat having a memorabilia signature affixed thereto;

FIG. 8 is a front perspective view of a sixth embodiment of the present invention showing a football having a memorabilia signature affixed thereto;

FIG. 9 is a front perspective view of a seventh embodiment of the present invention showing a baseball glove having a memorabilia signature affixed thereto;

FIG. 10 is a memorabilia shield in accordance with the present invention installed onto an athletic shoe;

FIG. 11 is a cross-sectional view taken along line 11-11 of FIG. 10; and

FIG. 12 is a detail view of the fastening bold of the memorabilia shield of FIG. 10.

### DETAILED DESCRIPTION OF THE INVENTION

Now referring to the drawings, the means and method for providing a sports item with hidden memorabilia is shown and generally illustrated in the figures. As can be seen the general principle of the present invention provides a carrier item as will be more fully described below that has an item of memorabilia attached thereto. Once the memorabilia item is affixed to the carrier, the memorabilia item is concealed or obscured from view utilizing a tamper proof concealing means until the carrier item is purchased by the end consumer.

Generally, within the scope of the present invention, a carrier item is intended to describe any object that serves as base consumer item to be sold within the context of the present invention. The following list while not meant to be exhaustive provides examples of various items that may be illustrative of what is intended as a carrier item. For example, a carrier item may be athletic shoes; athletic apparel such as jerseys, uniform shirts, accessories, swimsuits; event souvenirs; athletic equipment such as balls, bats, gloves, helmets; entertainment items such as musical instruments, hats, costumes, etc. The above list is meant only to illustrate a few possible items that may serve as a carrier item and the definition of carrier item is not intended to be limited to an item on the list. The scope of possible carrier items must be construed to extend to any possible consumer item associated with the field of sports, celebrity or historic memorabilia.

Similarly, the term memorabilia item, within the context of the present invention is intended to describe any type sports, entertainment or historic memorabilia item that may be considered desirable for a consumer to acquire. Again, the following list while not meant to be exhaustive provides examples of various items that may be illustrative of what is intended as a memorabilia item. For example, a memorabilia item may be machine-imprinted or authentic handwritten signatures of famous sports, historic or entertainment personalities such as athletes, actors, politicians, animated characters, persons who have accomplished particular achievements; imprinted logo insignia; pieces of event-used objects such as jerseys, costumes, musical instruments, historic objects and sports equipment, etc. Further, it can be appreciated that a piece of an event used object may be shaped to resemble a miniature version of the original object. For example, if the memorabilia item is a piece of a baseball bat, the piece itself may be shaped in the form of a miniature baseball bat. The above list is meant only to illustrate a few possible items that may serve as a memorabilia item and the definition of memorabilia item is not intended to be limited to an item on the list. The scope of possible memorabilia items must be construed to extend to any possible memorabilia item associated with the field of sports, celebrity or historic memorabilia.

Accordingly, the general concept provided in the disclosure of the present invention is as follows:
1) Provide a line of carrier items with a predetermined display location thereon.
2) Select a portion of the carrier items within the line to which an authentic memorabilia item is affixed in the display location.
3) Affix an optional decoy memorabilia item that is identical in shape and size to the authentic memorabilia item to the display location on the remaining portion of carrier items.
4) Conceal the authentic and decoy memorabilia items with memorabilia seal comprising a tamper proof concealing means.
5) Optionally, attach a memorabilia shield to the carrier item that serves to protect the memorabilia seal and further conceal the memorabilia item.

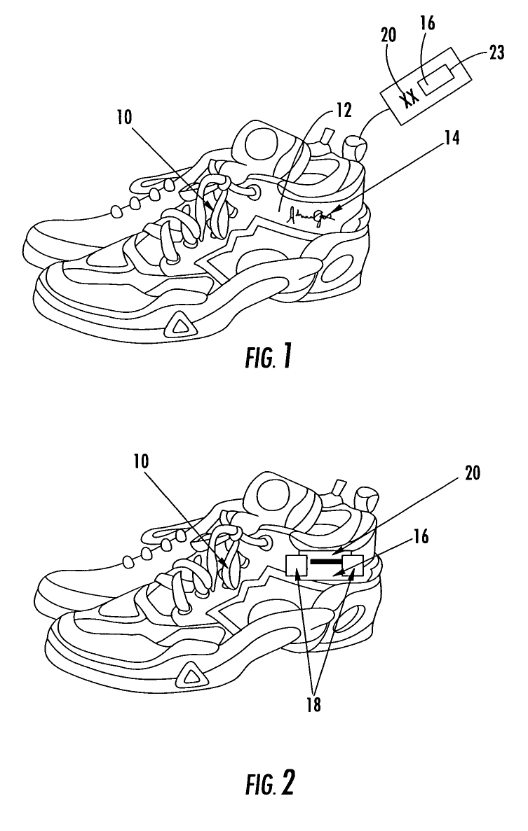

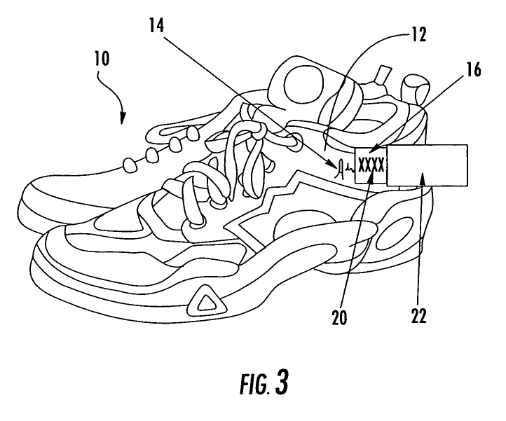

Turning now to the FIGS. 1 and 2, the present invention is illustrated in the context of a pair of athletic shoes 10. The athletic shoes 10 in this example are the carrier item 10, although as stated above the carrier item 10 may be any consumer product. A manufacturer produces a series of carrier items 10 in the form of athletic shoes 10, each having a display area 12 provided thereon. The series of athletic shoes 10 are separated into two portions. A first portion of the shoes 10 has an authentic memorabilia item 14 affixed thereto. In this case, the memorabilia item 14 is illustrated as an authentic, hand written celebrity signature that is signed directly onto the display area 12 of the athletic shoe 10, although as described above the memorabilia item 12 could be a large variety of different items. A second portion of the athletic shoes 10 has a decoy memorabilia item 14 affixed thereto. The decoy memorabilia item 14 is a machine imprinted signature that is printed onto the display area 12 of the shoe 10. If the memorabilia item 14 is an object such as a piece of athletic equipment, the display area 12 may consist of a pocket in the carrier item 10 into which the memorabilia item 14 is affixed. As can be seen best in FIG. 2, a memorabilia seal 16 is then applied over the display area 12 of all of the athletic shoes 10 in the series to conceal both the authentic and decoy memorabilia items 14. Further, the memorabilia seal 16 can be seen to include a tamper proofing means 18 to prevent a person from trying to determine whether or not they have a pair of athletic shoes 10 bearing an authentic or decoy memorabilia item 14 prior to purchasing the athletic shoes 10.

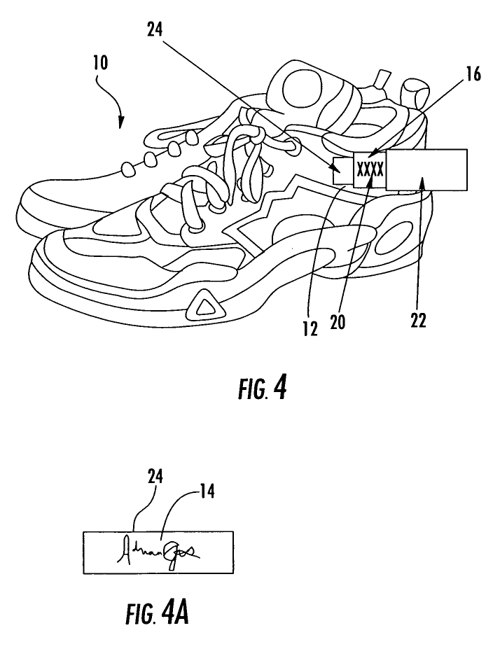

Turning now to FIG. 3, the memorabilia seal 16 including integrated tamper-proof features is shown installed on top of the memorabilia item 14 so that a potential purchaser cannot tell what, if anything, is hidden beneath the memorabilia seal 16 without tampering with the memorabilia seal 16. It is also noted that in the context of retail sales, the memorabilia seal 16 must not have been tampered with if a carrier item 10 is returned for a replacement or refund. To facilitate tracking and authentication of the discrete carrier items 10 within a particular series, the memorabilia seal 16 may have an optional Unique Identification Number (UIN) 20 imprinted or affixed thereon. As will be described more fully below, the UIN 20 can be used as part of the authentication process.

As is also shown in FIG. 3, a memorabilia shield 22 may be optionally attached to the carrier item 10. The purpose of the memorabilia shield 22 is to protect the memorabilia seal 16 from being disturbed while the carrier item 10 is being shipped, handled, stored, displayed, tried-out or tried-on. As is common in the retail industry, the memorabilia shield 22 is intended to be constructed similar to the plastic safety tags already in use by retailers. The memorabilia shield 22 is made from a mar-resistant and fingerprint-resistant plastic or metal material having a size and shape sufficient to cover the memorabilia seal 16 thereby making it virtually impossible for a person to accidentally damage or intentionally tamper with the memorabilia seal 16 without first removing partially or completely the memorabilia shield 22. Further the memorabilia shield 22 is intended to be unobtrusive visually so as to not interfere with displaying the carrier item 10 while also being small and thin with no sharp corners or edges to ensure convenience and safety while trying out or trying on the carrier item 10. The memorabilia shield 22 is made from rigid materials that make it difficult for a consumer to bend or dislodge the memorabilia shield 22 preventing the consumer from looking beneath the memorabilia shield 22. Additionally, if a memorabilia shield 22 is used on the carrier item 10, it may also be configured to include the required elements that would allow it to be used as part of an existing anti-theft system. For example, the memorabilia shield 22 may include special markings and/or signal emitters similar to those used in the Ultra*Gator® safety tags from Sensormatic Electronics Corporation. The memorabilia shield 22 is fastened to a carrier item 10 by means that prevent it from being removed except by an authorized person using special equipment after payment is made for the carrier item 10 or proof of ownership is shown. The memorabilia shield 22 may be attached with one or more pin tacks (not shown) similar to Ultra*Gator® safety tags from Sensormatic Electronics Corporation.

Once a configuration for the use of memorabilia seals 16 and memorabilia shields 22 is determined, the configuration must be consistently used throughout a particular series of carrier items 10. In particular, if it was decided to use memorabilia seals 16 by themselves to hide the memorabilia items 14 in a series of carrier items 10, then every single carrier item 10 in the series would only have memorabilia seals 16. Similarly, if a series of carrier items 10 included the use of memorabilia shields 22, then every carrier item 10 would also include a memorabilia shield 22.

After a customer completes the purchase of the carrier item 10, the purchaser of the carrier item 10 would then either remove the memorabilia seal 16 right at the point-of-acquisition, optionally leave the memorabilia seal 16 untouched for later sale, trade or display, or remove the memorabilia seal 16 in private at a later time. When the memorabilia seal 16 is removed and a memorabilia item 14 is revealed, the memorabilia item 14 may then be authenticated. The authentication of the memorabilia item 14 may be accomplished in several ways depending on the preferred method. For example, the sales clerk may fill in a certificate of authenticity for the memorabilia item 14, the sales clerk may arrange to have a certificate of authenticity sent to the owner of the memorabilia item 14, or the owner of the memorabilia item 14 may request the certificate of authenticity either at a website on the Internet or by telephone or facsimile. As was stated above, if a UIN 20 is provided on the memorabilia seal 16, the UIN 20 may be used to verify that the memorabilia item 14 found on the carrier item 10 is an authentic memorabilia item 14 as originally affixed to the carrier item 10 by the manufacturer.

Alternatively, the memorabilia item 14 may be affixed to the carrier item 10 and allowed to remain in plain view. Authentication of the memorabilia item 14 is accomplished through the use of a tag 23 affixed to the carrier item 10. The tag 23 would include a UIN 20 or other form of verification or authentication thereon. Further the tag 23 may or may not include a memorabilia seal 16 that serves to conceal the UIN 20. The tag 23 may be a hang tag as shown or a typical tag sewn into the carrier item 10 such as a shirt tag or a tag on the tongue of an athletic shoe.

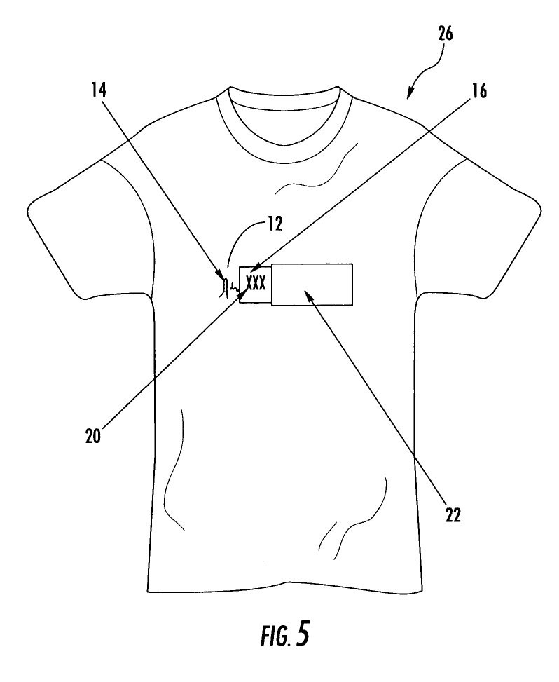

Turning now to FIGS. 4 and 4A the memorabilia item 14 may be affixed to a secondary carrier 24 that is installed onto the original carrier item 10 and concealed under the memorabilia seal 16. In this manner, once the memorabilia item 14 is discovered, the secondary carrier 24 can be separated from the original carrier item 10 allowing the original carrier item 10 to be fully functional and used for its intended purpose while allowing the secondary carrier 24 and the memorabilia item 14 affixed thereto to be safely stored. Similarly, the concealed memorabilia item 14 may be a certificate that is redeemed by the manufacturer or the retailer for a secondary carrier item 24 that can be worn, stored or otherwise used, thus leaving the original carrier item 10 free to be stored, displayed, traded, or sold by its owner. Finally, in some cases, the certificate of authenticity may include a picture of the sport or entertainment personality wearing or using the memorabilia and/or could be a memorabilia card of the type described in U.S. Pat. Nos. 5,803,501 and 6,142,532.

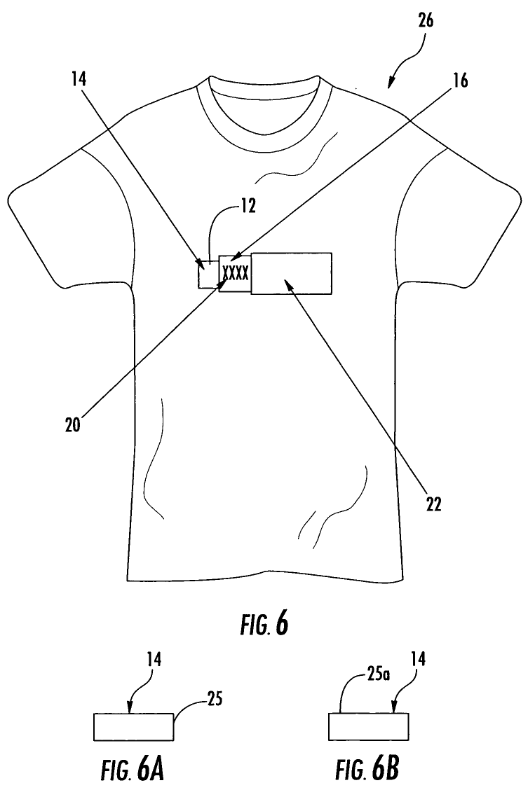

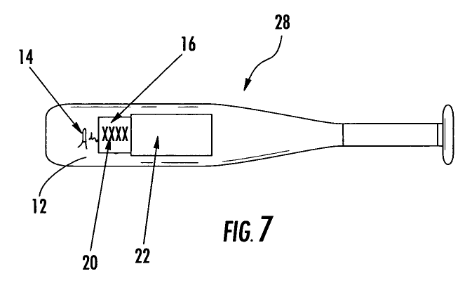

Turning now to FIGS. 5-9, the present invention is illustrated in the context of several different carrier items. FIGS. 5 and 6 illustrate the carrier item as being a jersey or t-shirt 26. In FIG. 5, a signature memorabilia item 14 is affixed to the display area 12 on the carrier item 26 and a memorabilia seal 16 with an optional memorabilia shield 22 is installed thereon. In FIGS. 6 and 6A, a memorabilia item 14 is provided that is an object 25 such as a piece of fabric that was originally a part of a game worn jersey. Alternatively, the memorabilia item 14 could comprise a redeemable certificate 25a thereby allowing the memorabilia item 14 to be separated from the shirt 26 and the shirt 26 to be worn without fear of damaging the memorabilia item 14. Still further, as stated above, the memorabilia item 14 could be a piece of a bat formed into the shape of a miniature baseball bat.

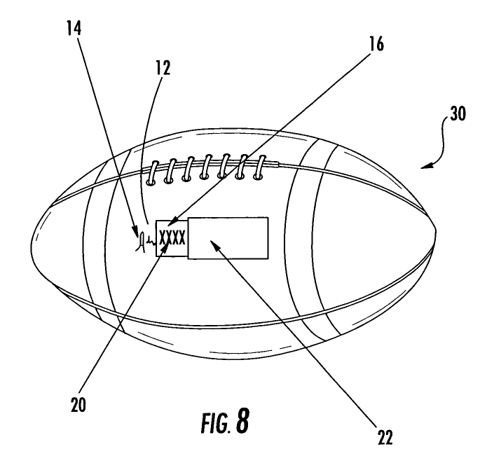

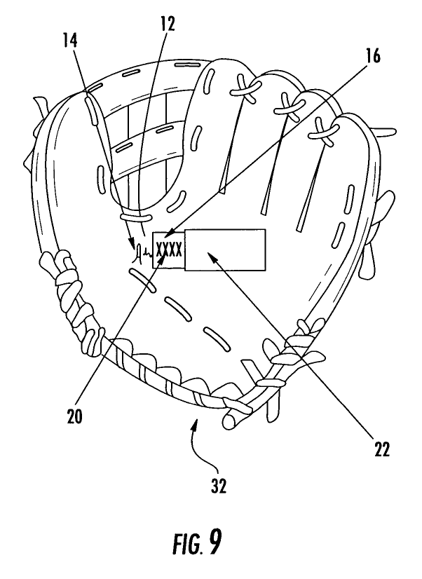

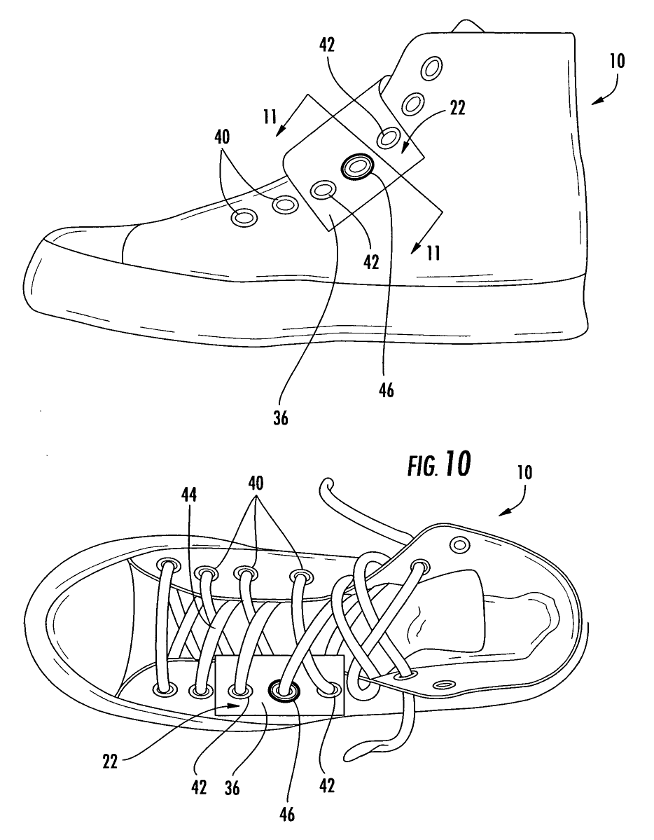

FIG. 7 shows a baseball bat 28 serving as a carrier item 10 in accordance with the disclosure provided above, FIG. 8 shows a football 30 serving as a carrier item 10 in accordance with the disclosure provided above and FIG. 9 shows a baseball glove 32 serving as a carrier item 10 in accordance with the disclosure provided above.

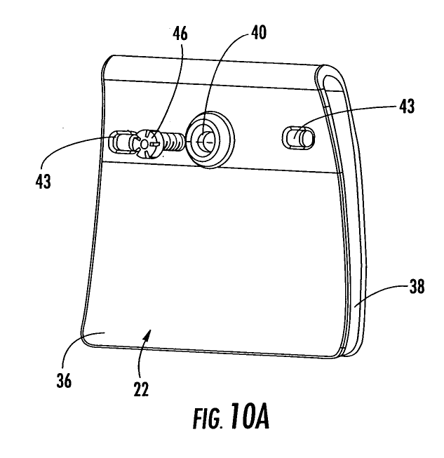

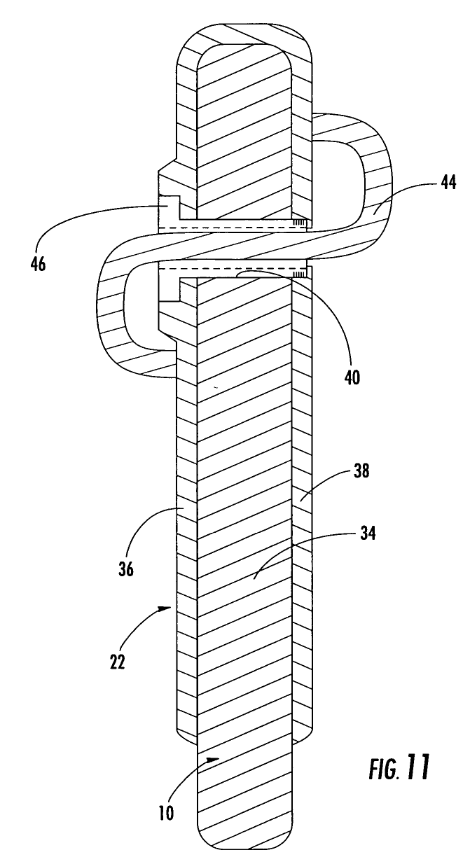

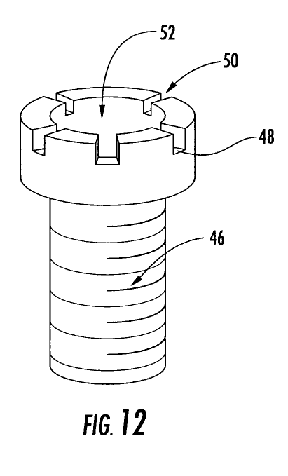

Turning now to FIGS. 10-12, an embodiment of a memorabilia shield 22 is shown in the context of an athletic shoe carrier item 10. The memorabilia shield 22 is shown as a clip the wraps around a portion of the top of the shoe lace area 34 of the athletic shoe 10. The memorabilia shield 22 has an inside flap 36 and an outside flap 38. While it is preferred that the inside 36 and outside 38 flaps are approximately the same length, this is not a required limitation. The memorabilia shield 22 extends over at least one of the shoelace holes 40 in the athletic shoe 10 and preferably extends over three of the lace holes 40. Holes 42 are provided through the memorabilia shield 22 at locations corresponding to the covered shoelace holes 40 to allow the shoelace 44 to be correctly threaded. To allow for variation in the spacing of the shoelace holes 40 in athletic shoe 10, FIG. 10A illustrates that the holes 43 may be elongated. In at least one of the holes 42, a hollow center security bolt 46 is installed extending through one of the flaps 36, 38 and being threadedly fastened to the opposite flap 36, 38. The security bolt 46 is configured in a manner that required special tools for its removal. For example, the security bolt 46 shown here has a unique head 48 design with five notches 50 requiring a custom screwdriver for its removal. A hole 52 is provided in the center of the bolt 46 so that a shoe lace 44 can be threaded through the hole with the bolt 46 installed.

The present invention has several benefits. First, similar to the use of special insert cards in packs of trading cards, one object of the present invention is to create an element of pleasant surprise that makes the consumer's shopping experience more exciting. Further the present invention adds a new design element to the line of carrier items 10, thus enabling product manufacturers, distributors, dealers, and retailers to increase sales by creating a wider range of differentiated carrier items 10. For example, the present invention makes it possible to offer different variations of the same carrier items 10 within the same product line, thereby creating a new market for collecting sets that may include more than one, and possibly all, of the versions of a carrier item 10. One group of carrier items in a product line may include a memorabilia item in the form of silver colored machine-imprinted signatures, another group of carrier items may have gold machine-imprinted signatures, and yet another group of carrier items may have authentic handwritten signatures. Accordingly a collector could collect all three versions of the same carrier item 10 in order to make a complete set. Additionally, the present invention serves to generate an aspect of novelty, fun and excitement thus enabling a wide range of sales promotion and advertising opportunities for the manufacturers, distributors, dealers and retailers of the carrier items 10 while providing an opportunity for more consumers to own memorabilia 14. Alternately, the memorabilia shield 22 may be shaped and decorated to provide additional novelty and fun by shaping the memorabilia shield 22 into a shape like a character, logo, image or piece or athletic equipment, such as for example a football or a cartoon character. Finally, the present invention may serve to create a friendlier anti-theft system.

It can therefore be seen that the present invention provides a novel and unique means and method for providing carrier items 10 with valuable and collectible memorabilia items 14 affixed thereto in a manner that is easily controlled and monitored while adding an aspect of chance and excitement to a consumer's shopping experience. Further, the present invention provides for a method that can be utilized in connection with a wide variety of carrier items 10 and memorabilia items 14 ultimately expanding the overall market for auctions and online trading of consumer products that are manufactured in accordance with the disclosure provided herein. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

1. A consumer item including an associated memorabilia item affixed thereto, said consumer item comprising:
a carrier item, said carrier item having a display area thereon;
a memorabilia item affixed to said display area on said carrier item; and
a memorabilia seal affixed to said carrier item over said memorabilia item, wherein said memorabilia seal conceals said memorabilia item until said memorabilia seal is removed from said carrier item.

2. The consumer item of claim 1, wherein said memorabilia seal includes anti-tamper features.

3. The consumer item of claim 1, wherein said memorabilia seal includes a unique identification code imprinted thereon.

4. The consumer item of claim 1, further comprising:
a memorabilia shield affixed to said carrier item, said memorabilia shield affixed in overlying relation to said memorabilia seal preventing access to said memorabilia seal.

5. The consumer item of claim 4, said memorabilia shield including anti-theft components installed therein.

6. The consumer item of claim 4, said memorabilia shield bears the image or is formed in the shape of a character, logo or piece of athletic equipment.

7. The consumer item of claim 4, said memorabilia shield being affixed to said carrier item using at least one fastener.

8. The consumer item of claim 7, wherein said fastener is configured in a manner that requires a customized tool for removal.

9. The consumer item of claim 1, wherein said carrier item is selected from the group consisting of:
athletic shoes, athletic apparel, jerseys, uniform shirts, t-shirts, athletic accessories, swimsuits, event souvenirs, athletic equipment, balls, bats, gloves, helmets, historic items, musical instruments, hats and costumes.

10. The consumer item of claim 1, wherein said memorabilia item is a signature.

11. The consumer item of claim 1, wherein said memorabilia item is at least a piece of an authentic implement used either by a popular sport, entertainment or historic person during a memorable event, wherein less than all of the implement is included.

12. The consumer item of claim 11, wherein said memorabilia item is selected from the group consisting of:
an imprinted logo insignia, a jersey, a uniform, a costume, a musical instrument, an historic object and an item of sports equipment.

13. The consumer item of claim 1, further comprising:
a first and second plurality of carrier items;
a first and second plurality of memorabilia items affixed to said first and second plurality of carrier items respectively, wherein said first plurality of memorabilia items are authentic and said second plurality of memorabilia items are decoys.

14. The consumer item of claim 13, wherein said memorabilia seal includes a unique identification code imprinted thereon, said unique identification code providing means for determining whether said memorabilia items are authentic or decoys.

15. The consumer item of claim 1, further comprising:
a secondary carrier item, said memorabilia item being affixed to said secondary carrier item, wherein said secondary carrier item is removably affixed to said display area on said carrier item.

16. A consumer item including a memorabilia item associated therewith, said consumer item comprising:
a carrier item, said carrier item having a display area thereon;
a certificate affixed to said display area on said carrier item, said certificate redeemable in exchange for a memorabilia item; and
a memorabilia seal affixed to said carrier item over said certificate, wherein said memorabilia seal conceals said certificate until said memorabilia seal is removed from said carrier item.

17. The consumer item of claim 16, wherein said memorabilia item is a signature.

18. The consumer item of claim 16, wherein said memorabilia item is at least a piece of an authentic implement used either by a popular sport, entertainment or historic person during a memorable event, wherein less than all of the implement is included.

19. The consumer item of claim 18, wherein said memorabilia item is selected from the group consisting of:
an imprinted logo insignia, a jersey, a uniform, a costume, a musical instrument, an historic object and an item of sports equipment.

20. A method of providing a consumer item which includes an associated memorabilia item affixed thereto, said method comprising the steps of:
providing a plurality of carrier items, each carrier item having a predetermined display location thereon;
affixing one of a plurality of memorabilia items to each of said display locations on each of said carrier items;
concealing said plurality of memorabilia items by applying a memorabilia seal over each of said display locations on each of said carrier items, wherein said memorabilia seal conceals said memorabilia item until said memorabilia seal is removed from said carrier item.

21. The method of claim 20, wherein said memorabilia seal includes anti-tamper features.

22. The method of claim 20, wherein said memorabilia seal includes a unique identification code imprinted thereon.

23. The method of claim 20, further comprising the step of:
affixing a memorabilia shield to said carrier item, said memorabilia shield affixed in overlying relation to said memorabilia seal preventing access to said memorabilia seal.

24. The method of claim 23, said memorabilia shield including anti-theft components installed therein.

25. The method of claim 23, said memorabilia shield being affixed to said carrier item using at least one fastener.

26. The method of claim 25, wherein said fastener is configured in a manner that requires a customized tool for removal.

27. The method of claim 20, said plurality of memorabilia items further comprising:
a first and second portion of said plurality of memorabilia items, wherein said first portion of memorabilia items are authentic and said second portion of memorabilia items are decoys.

28. The method of claim 27, further comprising the step of:
verifying the authenticity of said memorabilia item by verifying a unique identification code imprinted on said memorabilia seal, said unique identification code providing means for determining whether said memorabilia items are authentic or decoys.

29. The method of claim 20, further comprising the steps of:
providing a plurality of secondary carrier items;
affixing said memorabilia item to said secondary carrier item; and
removably affixing said secondary carrier item to said display area on said carrier item.

30. A consumer item including an associated memorabilia item affixed thereto, said consumer item comprising:
a carrier item, said carrier item having a display area thereon; and
a memorabilia item affixed to said display area on said carrier item.

31. The consumer item of claim 30, further comprising:
a memorabilia seal affixed to said carrier item over said memorabilia item, wherein said memorabilia seal conceals said memorabilia item until said memorabilia seal is removed from said carrier item.

32. The consumer item of claim 31, further comprising:
a memorabilia shield affixed to said carrier item, said memorabilia shield affixed in overlying relation to said memorabilia seal preventing access to said memorabilia seal.

33. The consumer item of claim 32, said memorabilia shield including anti-theft components installed therein.

34. The consumer item of claim 30, wherein said carrier item is selected from the group consisting of:
athletic shoes, athletic apparel, jerseys, uniform shirts, t-shirts, athletic accessories, swimsuits, event souvenirs, athletic equipment, balls, bats, gloves, helmets, celebrity items, musical instruments, hats and costumes.

35. The consumer item of claim 30, further comprising:
a tag attached to said consumer item, said tag bearing a means for authenticating said memorabilia item.

36. The consumer item of claim 35, further comprising:
a memorabilia seal in overlying relation with said means for authenticating said memorabilia item.

37. The consumer item of claim 30, wherein said memorabilia item is a signature.

38. The consumer item of claim 30, wherein said memorabilia item is at least a piece of an authentic implement used either by a popular sport, entertainment or historic person during a memorable event, wherein less than all of the implement is included.

39. The consumer item of claim 38, further comprising:
a tag attached to said consumer item, said tag bearing a picture depicting said popular sport, entertainment or historic person using or wearing said memorabilia item.

40. The consumer item of claim 39, wherein said carrier item is similar in appearance to said authentic implement.

41. A shield for concealing at least a portion of consumer item comprising:
a consumer item having a display area thereon;
a shield affixed to said carrier item, said shield affixed in overlying relation to said display area obscuring the visibility of said display area and preventing access to said display area.

42. The shield of claim 41, said shield including anti-theft components installed therein.

43. The shield of claim 41, said shield being affixed to said carrier item using at least one fastener, said fastener configured in a manner that requires a customized tool for removal.

44. The shield of claim 43, wherein said carrier item is an athletic shoe, said shield configured to be installed adjacent the lace portion of said athletic shoe, said shield including holes corresponding to lace holes in said athletic shoe, wherein said athletic shoe can be laced when said shield is installed.

45. The shield of claim 44, said at least one of said holes in said shield is larger that said lace holes.
